(19) United States
(12) Patent Application Publication
(10) Pub. No.: US 2021/0101267 A1
(43) Pub. Date: Apr. 8, 2021

(54) PLIERS FOR RELEASING A LINE CONNECTION

(71) Applicant: Ford Global Technologies, LLC, Dearborn, MI (US)

(72) Inventors: Ruben Boese, Königswinter (DE); Thomas Rother, Pulheim (DE); Olaf Denkel, Odenthal (DE); Alex F. Blesgen, Köln (DE)

(73) Assignee: Ford Global Technologies, LLC, Dearborn, MI (US)

(21) Appl. No.: 17/065,562

(22) Filed: Oct. 8, 2020

(30) Foreign Application Priority Data
Oct. 8, 2019 (DE) 102019126990.3

(51) Int. Cl. B25B 27/10; B25B 27/00

(52) U.S. Cl. CPC B25B 27/10; B25B 27/0035

(57) ABSTRACT

Pliers for releasing a line plug connection, formed by a line plug connector between a first line section and a second line section of a line in a region of a drive train of a motor vehicle includes two pliers legs. The pliers legs are connected together via a joint in order to open and close the pliers and together form a pliers head and a handling region. The pliers legs each have at the pliers head a part-sleeve, which, with the pliers closed, together form a sleeve for engaging around the line in the region of the second line section and for interacting with the line plug connector.

### CROSS-REFERENCE TO RELATED APPLICATIONS

This application claims priority to and the benefit of German Application Number 102019126990.3, filed on Oct. 8, 2019, the disclosure of which is incorporated herein by reference in its entirety.

### FIELD

The present disclosure relates to a tool for releasing a line plug connection, formed by a line plug connector, between a first line section and a second line section of a line, in particular in the region of a drive train of a motor vehicle.

### BACKGROUND

The statements in this section merely provide background information related to the present disclosure and may not constitute prior art.

In some technical fields, fastening a hose or other flexible line to a first line or some other connection part can pose a problem. Different fastening types are known, such as a purely force-fitting connection, in which the connection part is pushed into the hose and is retained therein by frictional forces. Additionally, screw connectors or snap-fitting connections are also known, wherein the hose has at its end a coupling element (e.g., a connector or a quick connector) that cooperates with the connection part in order to establish a form fit, for example.

In some applications, such as in pneumatically operated process plants or motor vehicles, one-part or multipart line plug connectors, in particular quick couplings or quick-fit connectors, include a hose, tube, or some other line that is plugged into a plug-in sleeve without additional fastening means. After being plugged in, the hose, tube, or other line is anchored automatically in the plug-in sleeve by barb elements and secured against being pulled out. In order to release the connection, a release ring, present on the plug-in sleeve, is pushed, typically manually, into the plug-in sleeve, wherein at the same time the tube or the hose can be released from the plug-in sleeve, likewise typically manually, by applying a pulling force. Although these connections work in principle, in some situations, on account of the confined space, it is difficult to reach the line plug connection for manual assembly or disassembly.

Such a situation can arise for example when attaching a heater hose in the engine compartment of a motor vehicle. The heater hose is typically installed or attached at a very late stage of assembly. In particular, in modern vehicles, there may be very little free space in the engine compartment. This can have the result that the hose has to be guided in a region that is too tight for an operator's hand or is able to be reached manually only with great difficulty. In DE 10 2017 212 536 A1, the problem is solved by a tool for guiding the heater hose of a motor vehicle into position, wherein the heater hose has a coupling element at its end. The tool clamps the hose, at the end remote from the user's hand, between two cheek elements and allows the fitter to fit a line plug connector to a line at a distance of at least 30-50 cm. The same problem also arises, however, when the heater hose is released.

U.S. Pat. No. 6,314,629,B1 discloses pliers for releasing a hose from a plug connection, in which a jaw unit of the pliers forms a clamped connection with the hose with the aid of a rotatable clamping element. A second jaw unit forms, upon actuation of the pliers, a stop with the hose connector and as a result pulls the hose out of the receptacle of the hose connector.

In U.S. Pat. No. 8,341,816 B1, a hose is released from a hose connector. For this purpose, the user holds the hose in position with first pliers in one hand, while moving a release ring for releasing the hose connection with second pliers in the other hand.

Pliers for releasing a quick connection with one hand are known from WO 2006/079302 A1. Integrated into the pliers head in that case is a guide, which receives a hose to be released in the region of the quick connector. The first jaw unit of the pliers head has a carrier protrusion, which, when the pliers are operated, forms a force-fitting connection with the outer wall of the hose in the guide and, thus, firmly holds the hose. The second jaw unit can at the same time move a release ring relative to the sleeve and thus release the plug connection.

In a comparable manner, the hose is released from the quick fastener in U.S. Pat. No. 6,314,629 B1. The first jaw unit firmly holds the hose while the second jaw unit displaces the connector for releasing the plug connection.

In light of the above references, there is further room for improvement in the simplification of the operation of releasing a flexible line from a second line or some other connection part in confined space when a line plug connector is used, in particular a quick coupling. In particular, the pliers known from the above references have the drawback that they have to be attached laterally, that is to say perpendicularly to a longitudinal axis or central axis of the hose or line plug connector. By contrast, if only a narrow assembly channel is available for releasing the hose, for example in the engine compartment of a motor vehicle, it is not possible to use the pliers of the above references.

### SUMMARY

This section provides a general summary of the disclosure and is not a comprehensive disclosure of its full scope or all of its features.

The present disclosure is based on simplifying the operation of connecting a flexible line to a second line or some other connection part in a confined space using a line plug connector, and improving it from an ergonomical point of view for the fitter or mechanic.

According to one form of the present disclosure, pliers for releasing a line plug connection that is formed by a line plug connector in the region of a drive train of a motor vehicle have the features of claim 1, wherein the dependent claims relate to additional configurations of the present disclosure.

The features and measures listed individually in the following description can be combined with one another in any desired, technically appropriate manner and indicate further configurations of the present disclosure. The description additionally characterizes and specifies the device of the present disclosure in particular in conjunction with the figures. Where the following description refers to a “line,” this serves merely for illustration. The term “line” as used herein extends to all kinds of flexible or rigid medium hoses such as heater hoses, radiator hoses (disco tool), but also electric lines, waveguides or glass-fiber cables. The term “first line section” as used herein relates to the line section that is removed with the pliers when the line plug connection is released. The term “second line section” as used herein relates to the line section that remains generally fixed in position, for example in the engine compartment after the line plug connection has been released. A “second line section” can form any kind of line or connection piece, for example at the manifold connection in the region of the drive train. A “line plug connector” as used herein should be understood as being any one-part or multipart plug-in system or quick coupling system for forming a line plug connection with a line, consisting of at least two line sections.

The present disclosure relates to pliers for releasing a line plug connection, formed by a line plug connector between a first line section and a second line section of a line, in the region of a drive train of a motor vehicle. Pliers according to the present disclosure have two pliers legs, which are connected together via a joint in order to open and close the pliers and together form a pliers head and a handling region. The pliers legs each have, at the pliers head a part-sleeve, which, with the pliers closed, together form a sleeve for engaging around the line in the region of the second line section and for interacting with the line plug connector.

Such a line plug connector can be configured as a one-part or multipart quick coupling and has, in one form, a substantially cylindrical plug-in sleeve with a central axis, in which at least the second line section is received. In the plug-in sleeve, barbs or other retaining features can be provided, which form an engagement in the outer wall of the second line section and prevent the second line section from being pulled out of the plug-in sleeve. Therefore, for pulling out in the case of such line plug connectors, a release ring or equivalent release device is provided on an end wall of the plug-in sleeve, said release ring being able to be displaced along the central axis and releasing the barbs from the second line section. As a result of the pliers being formed with a sleeve according to the present disclosure for acting on the line plug connector, the release device can be actuated. As a result, when the line plug connection is released, the pliers can be held or applied substantially parallel to a central axis of the line plug connector and/or of the first line section. As a result, the disassembly of the line connection is possible even when only a narrow assembly channel is available for the user. By way of the pliers, the force for actuating the release device for releasing the line plug connection can be applied by a pulling movement with the hand or arm in a pulling direction along the central axis of the line plug connector.

Such pliers, according to the present disclosure, can be provided in a cost-effective manner as an accessory for example for motor vehicle workshops. In particular, a heater hose and/or a radiator hose can be reliably reached from a distance by the mechanic or fitter given limited space. Use in process plants is also conceivable in principle. The necessary time for assembly and maintenance can be shortened, thereby reducing the costs therefor overall. For example, the configuration of the sleeve with flexible material allows the pliers to be used for different hose diameters.

In one form of the present disclosure, the sleeve formed at the pliers head has a narrow-walled or thin-walled sleeve portion, assigned to the line plug connector, which is configured to be pushed into the line plug connector of the line plug connection.

When the thin-walled sleeve portion is pushed in between the second line section and the line plug connector, the barbs or the other retaining or catching features are separated from the outer wall of the second line section. This inhibits damage to the second line section. The barbs or other retaining or catching features form the engagement after insertion with the outer wall of the thin-walled sleeve portion. In this way, it is possible for the line plug connector can be guided safely out of the motor vehicle through the assembly channel by the user with the pliers, for example. The thin-walled sleeve portion can be formed from rigid or flexible material.

In an optional form of the present disclosure, the sleeve disposed at the pliers head has a flange portion, which is configured to engage behind and/or to bear on the line plug connector and, when the line plug connection is released, can exert a pressure force on the line plug connector.

By way of the flange portion, it is possible to easily remove the line plug connectors to the end side of the plug-in sleeve of which a release ring is attached. As a result of the release ring being pressed against the plug-in sleeve, the barbs or other retaining or catching features are released from the second line section and the line plug connector can be stripped easily from the second line section with the pliers. As a result, it is also possible to avoid damage to the line by brute force.

In one form, the pliers legs have, in the handling region, a first gripping element and at least one second gripping element, wherein at least one gripping element is bent in a U shape to form a pulling device.

When the line plug connection is released, the pulling device forms a support for the edge or the little finger of the hand gripping the pliers in the handling region. As a result, the ergonomics of the pliers can be improved with cost-effective manufacturing measures and low material costs.

In one form, the pliers have a pliers length of at least 300 millimeters. In one form, the pliers have a length of about 388 millimeters. As a result of this total length, the pliers are particularly suitable for releasing line plug connectors in the interior of a motor vehicle without the fitter or mechanic having to pass their hand into the interior of the motor vehicle.

In one form of the present disclosure, the pliers, in particular the pliers head, have/has a light source for illuminating the line plug connection. In many cases, the assembly channel with the second line section is not only difficult to access but is also poorly illuminated. In order to make it easier to release and guide out the first line section, a light source for illuminating the region in front of the pliers head is, in one form, arranged at the pliers head. The light source can be formed for example by one or more LEDs, which are operated via a battery that is incorporated in the tool. A switch for switching the light source on and off can be arranged in the handling region.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a side view of an engine compartment of a motor vehicle without a line connection from the prior art;

FIG. 2 shows a side view corresponding to FIG. 1 with a line connection from the prior art;

FIG. 3a shows a perspective illustration of a human hand;

FIG. 3b shows a perspective illustration of pliers in one exemplary form according to the teachings of the present disclosure;

FIG. 4a shows a side view in a first position of an example of a disassembly operation according to the teachings of the present disclosure;

FIG. 4b shows a side view corresponding to FIG. 4a in a second position of an example of a disassembly operation according to the teachings of the present disclosure;

FIG. 5a shows a side view corresponding to FIG. 1 in a first position of the example of the disassembly operation according to the teachings of the present disclosure;

FIG. 5b shows a side view corresponding to FIG. 1 in a second position of the example of the disassembly operation according to the teachings of the present disclosure;

FIG. 5c shows a side view corresponding to FIG. 1 in a third position of the example of the disassembly operation according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

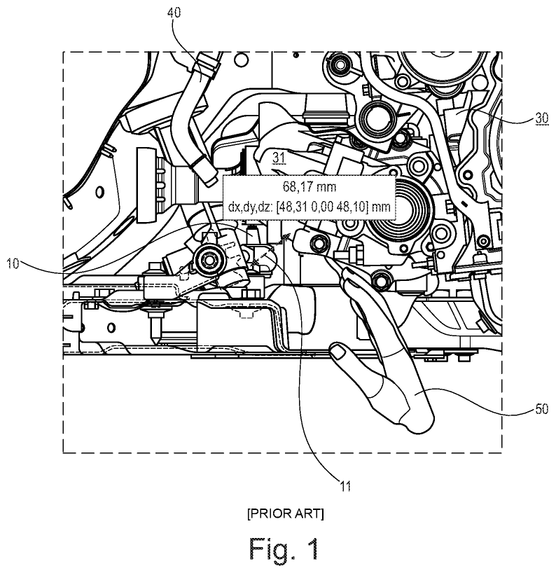

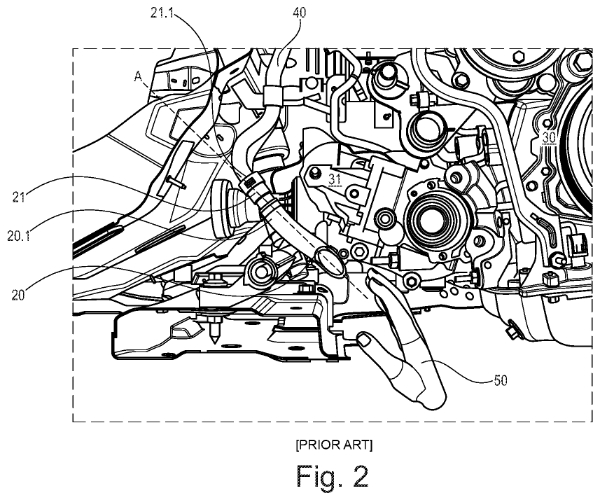

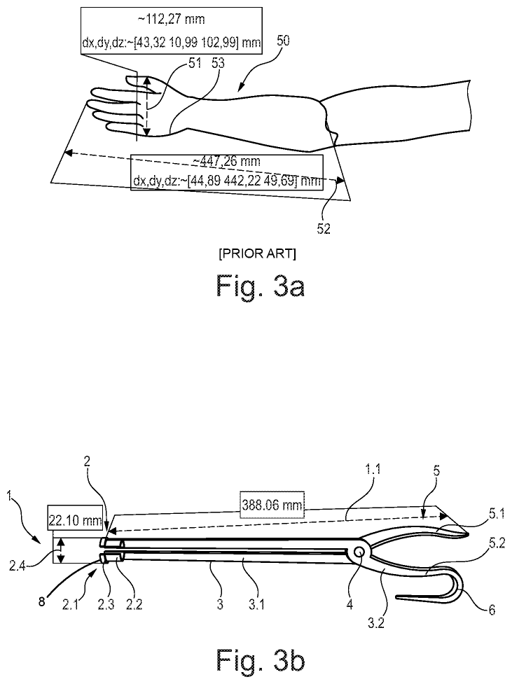

FIG. 1 shows the region of a drive train of a motor vehicle with an engine 30 and an AWD unit 31 with a second line section 40 of a line, to which a further first line section 20 (see FIG. 2) is intended to be connected. The second line section 40 is accessible to the human hand 50 of a mechanic or fitter only via a narrow assembly channel 10 as working area, the dimension of which in terms of width is, for example, just under 70 mm. Many human hands 50 are much wider than 70 mm. As illustrated by way of example in FIG. 3a, a human hand 50 can have a width 51 of between 100 mm and 120 mm, in particular 112 mm, and a length 52 from the elbow to the fingertips of 447 mm. Thus, the reach of the human hand 50 is also limited.

The same problem also arises according to FIG. 2 when releasing the first line section 20 from the second line section 40 at the line plug connector 21. It may be not possible, or may only be possible with difficulty and the risk of injury, for the human hand 50 to reach the end portion 20.1 of the first line section 20 and to actuate, at the line plug connector 21 or the quick coupling, the release ring 21.1 or some other release device for separating the line plug connection 21 and to disassemble the first line section 20. Also illustrated is the central axis A of the substantially rotationally symmetric or cylindrical line plug connector 21, which can form, at the same time, a central axis of the first line section 20 and of the central channel 10.

FIG. 3b shows an example of pliers 1 having two pliers legs 3 (only one of which is labeled), which are connected together via a joint 4 in order to open and close the pliers 1. Each pliers leg 3 is able to be subdivided at the joint 4 into a first leg portion 3.1 and a second leg portion 3.2. The two first leg portions 3.1 together form, at their end away from the joint 4, a pliers head 2. In one form, the pliers head 2 may optionally include a light source 8 for illuminating the line plug connection 21. The two second leg portions 3.2 form the gripping elements 5.1, 5.2 of the handling region 5. The first leg portions 3.1 are much longer than the second leg portions 3.2. In one form, the first leg portions 3.1 are at least twice as long as the second leg portions 3.2. In one form, the pliers 1 have a total length 1.1 of 388 mm. As a result of the length dimension, typical distances in a motor vehicle are readily bridgeable and so the hand 50 of the mechanic or fitter remains protected when operating the pliers 1.

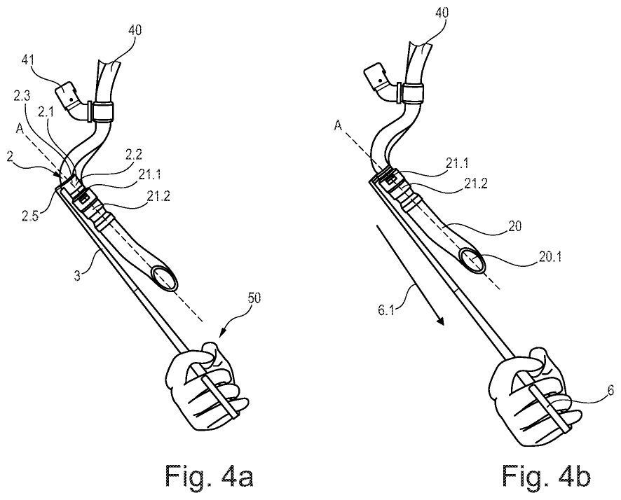

The pliers legs 3 each have at the pliers head 2 a part-sleeve, which, with the pliers 1 closed, can together form a cylindrical sleeve 2.1 for engaging around the line in the region of the second line section 40. The sleeve 2.1 is able to be subdivided, in its axial orientation, that is to say along its central axis, into two portions. The first portion of the sleeve 2.1 has two ring elements or ring halves, which, with the pliers 1 closed, form a flange portion 2.3, which engages around the second line section 40. In one form, the flange portions 2.3 can be the same size, i.e. each form ring halves. In another form, the ring elements can be embodied differently, such that one of the ring elements engages for example around only a quarter circumference and the other around half the circumference or three-quarters of the circumference of the second line section 40. In yet another form, the flange portion does not engage fully around the circumference of the second line section but only around a part of the circumference thereof. In this way, weight can be saved, making handling easier. For example, the two flange portions can engage around only a quarter circumference of the second line section 40. The second portion of the sleeve 2.1 is in the form of a narrow-walled or thin-walled sleeve portion 2.2 assigned to the line plug connector 21. It is configured to be inserted into the line plug connector 21 of the line plug connection (FIG. 4b). It is expedient for the second portion of the sleeve 2.1 to be embodied such that it engages around the entire circumference of the second line section 40. In this regard, the sleeve 2.1 can engage, with its two portions, differently around the second line section as seen in the circumferential direction, wherein the second portion appropriately realizes engagement around the entire circumference. In the example provided, the sleeve 2.1 has a sleeve diameter 2.4 of less than 30 mm. In one form, the sleeve 2.1 has a sleeve diameter 2.4 of 22 mm.

In the handling region 5, when pliers 1 are used, a first gripping element 5.1 is typically assigned to the palm of the hand and a second gripping element 5.2 is typically assigned to the fingers. The second gripping element 5.2 assigned to the fingers is bent or curved in a U shape so as to form a pulling device 6.1.

FIG. 4a shows an application of the pliers 1. The pliers 1 are configured to engage behind and/or to bear on the line plug connector 21. The sleeve 2.1 has two part-sleeves, which are each connected to the pliers legs 3 via a connecting web 2.5. The connecting web 2.5 is substantially perpendicular to the adjoining pliers legs 3 and lies in a plane with the flange portion 2.3. Thus, the flange portion 2.3 and the pliers legs 3 substantially also enclose a right angle. The pliers head 2 is guided in an open or closed manner past the line plug connector 21. In the open state, the pliers head 2 engages behind the line plug connector 21. When the pliers 1 are closed, the part-sleeves of the sleeve 2.1 engage around the second line section 40, which is connected in a stationary manner, for example to the motor vehicle, by way of a fastening device 41. In this case, a central axis of the sleeve 2.1 of the pliers 1 comes to be substantially coincident with a central axis A of the line connector 21.

In FIG. 4b, the user, supported by the pulling device 6 in the region of the handling device 5, is initiating a pulling movement in a pulling direction 6.1. The pulling direction 6.1 extends substantially parallel to the central axis A of the line plug connector 21 and/or of the first line section 20 and/or of the pliers legs 3. The illustrated line plug connector 21 has a release ring 21.1 and a plug-in sleeve 21.2, which is connected firmly, for example by a hose clip, to an end portion 20.1 of the first line section 20. While the pulling movement in the pulling direction 6.1 is being carried out, the flange portion 2.3 comes into abutment with the release ring 21.1 and exerts a pressure force thereon that displaces the release ring 21.1 along the central axis A in the pulling direction 6.1 and relative to the plug-in sleeve 21.2. At the same time, the narrow-walled or thin-walled sleeve portion 2.2 slides between the second line section 40 and the line plug connector 21, such that any barbs or other retaining or catching features can form a force-fitting or frictional connection with the sleeve 2.1 and thus the pliers 1. Therefore, it is appropriate for the second portion of the sleeve 2.1 to engage around the entire circumference of the line section 40 since in this way any barbs or other retaining or catching features can certainly bring about the connection with the sleeve 2.1. Upon abutment of the flange portion 2.3 against the release ring, by contrast, abutment around part of the circumference may be sufficient in order to apply the necessary pressure force.

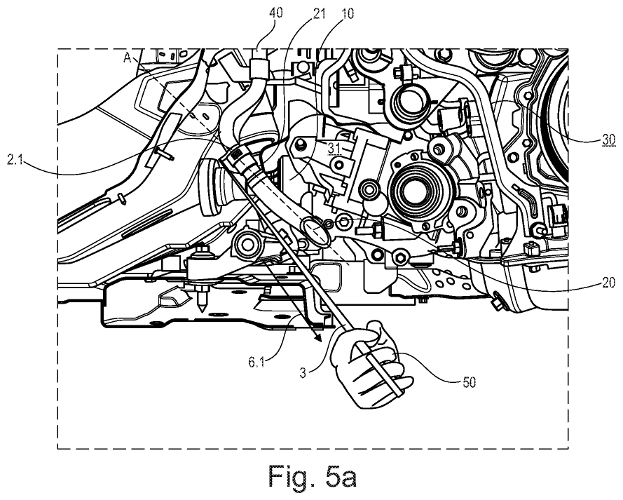

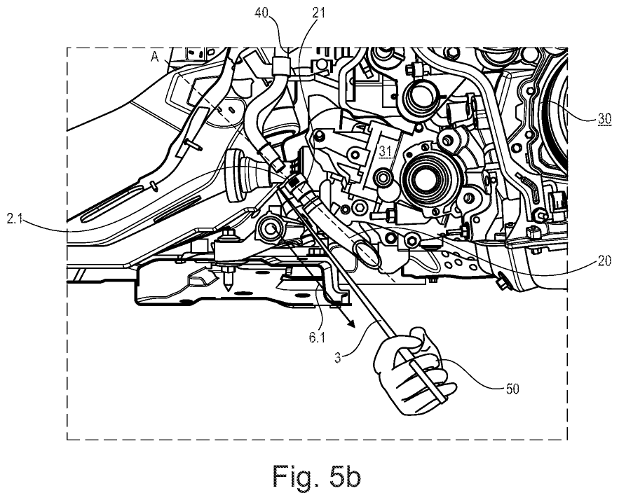

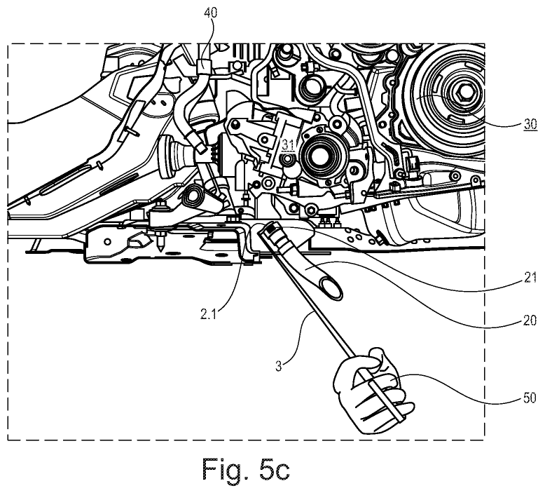

FIG. 5a shows the depiction according to FIG. 4b when applied in a motor vehicle. As a result of the choice of pliers 1 with a sleeve diameter 2.4 of at most 30 mm in the region of the pliers head 2, e.g., 22 mm, the available assembly channel 10 is wide enough to introduce the pliers 1 and to place the part-sleeves of the pliers head 2 around the second line section 40 and, by introducing the narrow-walled sleeve portion 2.2, bring it into engagement with the line plug connector 21. FIG. 5b shows how the line plug connector 21 forms a force-fitting or frictional connection with the sleeve 2.1 and as a result can be guided out of the motor vehicle exactly along the assembly channel 10. Finally, FIG. 5c shows the fully removed line plug connector 21 with the first line section 20.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. Pliers for releasing a line plug connection formed by a line plug connector between a first line section and a second line section of a line in a region of a drive train of a motor vehicle, the pliers comprising:
two pliers legs connected together via a joint in order to open and close the pliers, the pliers legs together form a pliers head and a handling region, each pliers leg has a part-sleeve at the pliers head, wherein, with the pliers closed, the part-sleeves together form a sleeve for engaging around the line in a region of the second line section and for interacting with the line plug connector.

2. The pliers according to claim 1, wherein the sleeve formed at the pliers head has a narrow-walled sleeve portion configured to engage the line plug connector and configured to be pushed into the line plug connector of the line plug connection.

3. The pliers according to claim 2, wherein the narrow-walled sleeve portion is configured to be slid between the second line section and the line plug connector such that a retaining or catching feature of the line plug connector is disengaged from the second line section and is engaged to the narrow-walled sleeve portion.

4. The pliers according to claim 2, wherein the pliers head includes a flange portion configured to abut a release ring of the line plug connector.

5. The pliers according to claim 2, wherein the sleeve formed at the pliers head has a flange portion configured to engage behind the line plug connector, to bear on the line plug connector, or to engage behind the line plug connector and bear on the line plug connector, wherein when the line plug connection is released, the flange portion is configured to exert a pressure force on the line plug connector.

6. The pliers according to claim 1, wherein the sleeve formed at the pliers head has a flange portion configured to engage behind the line plug connector, to bear on the line plug connector, or to engage behind the line plug connector and bear on the line plug connector, wherein when the line plug connection is released, the flange portion is configured to exert a pressure force on the line plug connector.

7. The pliers according to claim 1, wherein the pliers legs include, in the handling region, a first gripping element and a second gripping element, wherein at least one of the first gripping element and the second gripping element is bent in a U shape to form a pulling device.

8. The pliers according to claim 1, wherein the pliers have a total length of at least 300 millimeters.

9. Pliers according to claim 8, wherein the pliers have a total length of 388 millimeters.

10. The pliers according to claim 8, wherein the pliers legs are at least twice as long as the handling region.

11. The pliers according to claim 1, wherein the pliers head includes a light source configured to illuminate the line plug connection.

12. The pliers according to claim 1, wherein the sleeve is disposed at least partially about a central axis that is offset from the pliers legs.

13. The pliers according to claim 12, wherein the part-sleeves extend around equal amounts of a circumference of the sleeve.

14. The pliers according to claim 12, wherein the sleeve extends less than a full circumference about the central axis.

15. The pliers according to claim 1, wherein each part-sleeve is connected to the corresponding pliers leg by a connecting web that extends substantially perpendicular to the pliers legs.

16. A method of releasing a line plug connection formed by a line plug connector between a first line section and a second line section of a line in a region of a drive train of a motor vehicle, the method comprising:
providing pliers including a pair of pliers legs connected together via a joint in order to open and close the pliers, the pliers legs together forming a pliers head and a handling region, each pliers leg having a part-sleeve at the pliers head, wherein, with the pliers closed, the part-sleeves together form a sleeve;
positioning the pliers in a first position in which the sleeve is disposed around the line in a region of the second line section;
moving the pliers to a second position in which a portion of the sleeve is in a force-fitting or frictional connection with the line plug connector; and
moving the pliers to a third position in which the line plug connector is disconnected from the second line section.

17. The method according to claim 16, wherein moving the pliers from the first position to the second position includes moving the pliers in a direction substantially parallel to a central axis of the line plug connector.

18. The method according to claim 16, wherein moving the pliers to the second position includes sliding a portion of the sleeve between the second line section and the line plug connector.

19. The method according to claim 18, wherein the force-fitting or frictional connection between the sleeve and the line plug connector is such that a retaining or catching feature of the line plug connector is disengaged from the second line section and is engaged to the portion of the sleeve.

20. The method according to claim 18, wherein the pliers head includes a flange portion configured to abut a release ring of the line plug connector.
